(19) United States
(12) Patent Application Publication
(10) Pub. No.: US 2002/0178766 A1
(43) Pub. Date: Dec. 5, 2002

(54) Luggage security device

(76) Inventors: Bernon B. Jackson JR., Bedford, TX (US); David B. Smith, Euless, TX (US)

Correspondence Address: Lars D. Jensen, Jensen R&D Corporation, 5720 Forest Bend Drive, Arlington, TX, 76017, US

(21) Appl. No.: 09/873,543

(22) Filed: Jun. 4, 2001

(51) Int. Cl. E05B 73/00; B65D 55/14

(52) U.S. Cl. 70/18; 70/164

(57) ABSTRACT

A security device having one or more straps, which surround a piece of luggage and fasten together by means of grommets stacking over a common base. The base has an aperture for receiving a lock, thus securing the grommets on the base. A doubling-back of one or more of the strap ends provides a mechanical advantage for drawing tightly. One version includes a base whose position can be adjusted. The invention can be used to secure a piece of luggage or any object.

### BACKGROUND

When traveling by carriers such as buses, airplanes, trains or ships, it is common for the traveler's luggage to be carried separately, outside of the control of the traveler. During this time, the luggage is susceptible to search, vandalism, and theft by unscrupulous persons.

Luggage manufacturers provide security features that are largely psychological deterrents. Typical locks and hasps are made of flimsy metal and most keys will open many other locks. Given the state-of-the-art today, the average traveler would admit that their luggage is not very secure.

The carriers make efforts to keep the luggage in guarded areas, and ensure that handling personnel are trustworthy. In spite of this, the U.S. Department of Transportation estimates that there are 2,000,000 lost, stolen, or damaged bags each year, domestically.

Accordingly, there is a clear need for a security device to provide real security to luggage.

### SUMMARY

It is an object of the present invention to provide a device which secures a piece of luggage against unwanted search or theft, by preventing the opening of the luggage lid or by blocking access to a luggage pocket. This objective is achieved by completely surrounding the piece of luggage with one or more straps.

A second object of the present invention to provide a security device which draws tightly around the piece of luggage. This objective is achieved by providing a loop means which directs a strap in the opposite direction thus effectively doubling the pull force.

A third object of the present invention to provide a security device which fits closely around a piece of luggage. This objective is achieved by providing a movable base, which can engage one or more openings at any desired strap circumference.

A fourth object of the present invention to provide a device which secures any object. This objective is achieved by completely surrounding the object with one or more straps having lengths and adjustable circumferences to suit that object.

Further objects and advantages of our invention will become apparent from a consideration of the drawings and ensuing description

### BRIEF DESCRIPTION OF THE DRAWINGS

The following figures describe the present invention:

FIG. 1 is a perspective view of one embodiment of the present invention prior to securing a piece of luggage.

FIG. 1A is a partial perspective view showing a base alternately secured to the first strap by means of a face plate.

FIG. 1B is a partial sectional view taken along line 1B-1B in FIG. 1, showing the base alternately secured to the first strap with a rivet edge.

FIG. 2 is a perspective view of the embodiment of FIG. 1 now in place around a piece of luggage and secured with a lock.

FIG. 3 is a perspective view of an alternate embodiment of the present invention having two straps, shown prior to securing a piece of luggage.

FIG. 3A is a partial perspective view showing an alternate loop means comprising a slotted piece.

FIG. 3B is a partial sectional view taken along line 3B-3B in FIG. 3, showing the base secured to the first strap with a fastener.

FIG. 4 is a perspective view of the embodiment of FIG. 3 now in place around a piece of luggage and secured with a lock.

FIG. 5 is a perspective view of an alternate embodiment of the present invention having a staple-shaped base and elongated openings.

FIG. 6A is a partial perspective view showing an alternate loop means of double rings.

FIG. 6B is a partial perspective view showing the double rings securing a piece of luggage.

FIG. 7A is a partial perspective view showing an alternate loop means of a draw buckle.

FIG. 7B is a partial perspective view showing the draw buckle securing a piece of luggage.

FIG. 8A is a partial perspective view showing a base secured by a slotted anchor plate.

FIG. 8B is a partial perspective view showing a base secured by a bent slotted anchor plate.

FIG. 9 is a partial perspective view showing a base secured by a mounting clip.

FIG. 10 is a perspective view of a preferred embodiment of the present invention having a base secured by a mounting clip and a double rings loop means.

FIG. 11 is a perspective view of the embodiment of FIG. 10 shown surrounding and locking an object.

FIG. 12 is a perspective view of an alternate embodiment of the present invention wherein each of the first and second straps comprises a loop means.

FIG. 13 is a partial perspective view showing a slotted panel for attaching a vertical strap to a horizontal strap.

FIG. 14 is a partial perspective view showing a splice strip for attaching the vertical strap to the horizontal strap.

FIG. 15 is a partial perspective view showing a ring for attaching the vertical strap to the horizontal strap.

### REFERENCE NUMERALS USED IN THE DRAWINGS

The following is a description of the referenced parts:

110. first strap

111. looping end

112. middle portion

113. free end

114. opening

115. base

116. aperture

117. rivet edge

118. washer

119. grommet

120. second strap

121. first loose end

122. central portion

123. second loose end

124. stitching

125. hole

126. fastener

127. slotted piece

128. slot

129. rivet

130. face plate

131. rivet

140. base

141. mounting clip

142. end

143. base

144. slotted anchor plate

145. slot

146. slotted anchor plate

147. bent end

148. slot

149. slotted panel

150. splice strip

151. stitching

160. ring

170. stitching

171. ring

172. first ring

173. second ring

174. draw buckle

175. middle bar

176. lower bar

210. first strap

214. elongated opening

215. base

216. aperture

219. elongated grommet

220. second strap

310. second strap

311. looping end

312. central portion

313. loose end

370. stitching

371. ring

410. lock

411. lock

412. vertical strap

422. horizontal strap

510. piece of luggage

511. piece of luggage

512. piece of luggage

513. piece of luggage

520. handle

521. handle

600. object

601. lock

### DETAILED DESCRIPTION OF THE INVENTION

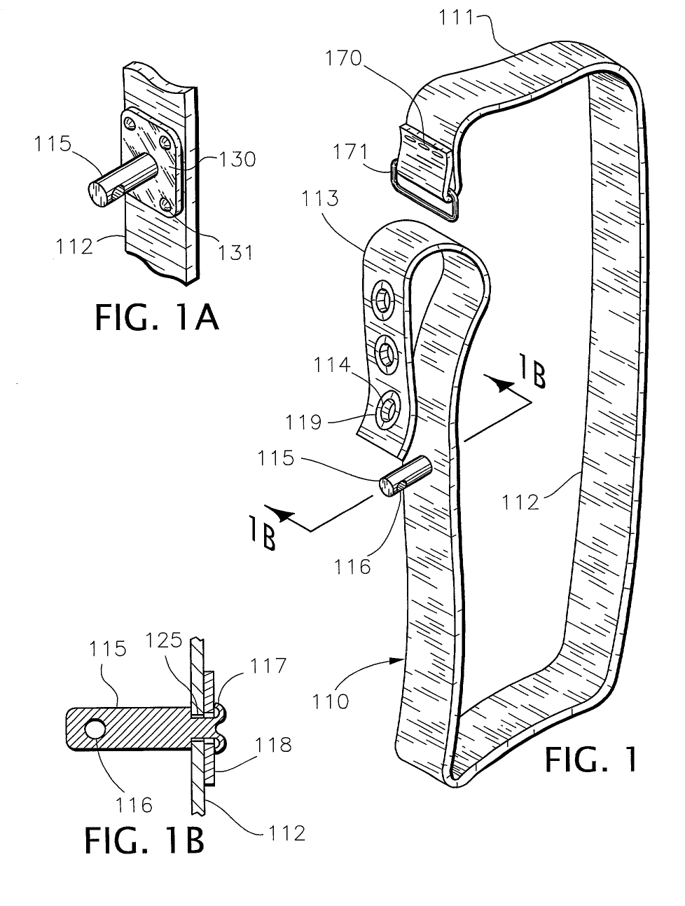

FIG. 1 shows the present invention comprising a first strap 110 having a looping end 111, a middle portion 112, and a free end 113. There is a base 115 which is shown having a cylindrical shape and an aperture 116 at one end. The base will also work if it has a non-cylindrical cross-sectional shape (such as a square or polygon.) The base could also be tapered or conical. The aperture should be sufficiently large to receive a typical lock. The aperture could have any non-circular shape, so long as it functions to receive a lock. The free end of the strap has one or more of a grommet 119 each of which forms an opening 114. Each opening should be sufficiently large in size to pass over the base. The grommets shown are common, made of a soft formable material such as brass or plastic. A bare opening which is cut, drilled, or formed in the strap would work (without the grommet.) However, such an opening might be weak or become frayed with use. One skilled in the art could place the openings at suitable distances and intervals to accommodate a majority of luggage heights.

FIG. 1A shows a means of securing the base 115 to the middle portion 112 by being attached to a face plate 130. The base is attached to the face plate by rivet edge, threaded screw, drive screw, cement, brazing, welding, or the like. Alternately, the base and face plate could be made as one integral part by molding or casting. The face plate is shown secured by one or more of a rivet 131. The face plate could also be secured by piercing prongs, deformed on the backside. A face plate with several small holes could also be secured by stitching. . Every embodiment of the present invention disclosed herein would work equally well having a means of securing the base comprising a face plate.

FIG. 1B shows a means of securing the base 115 to the middle portion 112 of the first strap 110, where integral to one end of the base is a tubular rivet shape. That end is inserted through a hole 125 in the strap. Then, the rivet edge 117 would be rolled back using a common rivet setting anvil. This version shows a washer 118 under the rivet edge. But, another version, having the rivet edge rolled to a large diameter, could omit the washer. Another version could include a second washer (not shown) placed on the other side of the strap. Yet other means of securing the base will be described later.

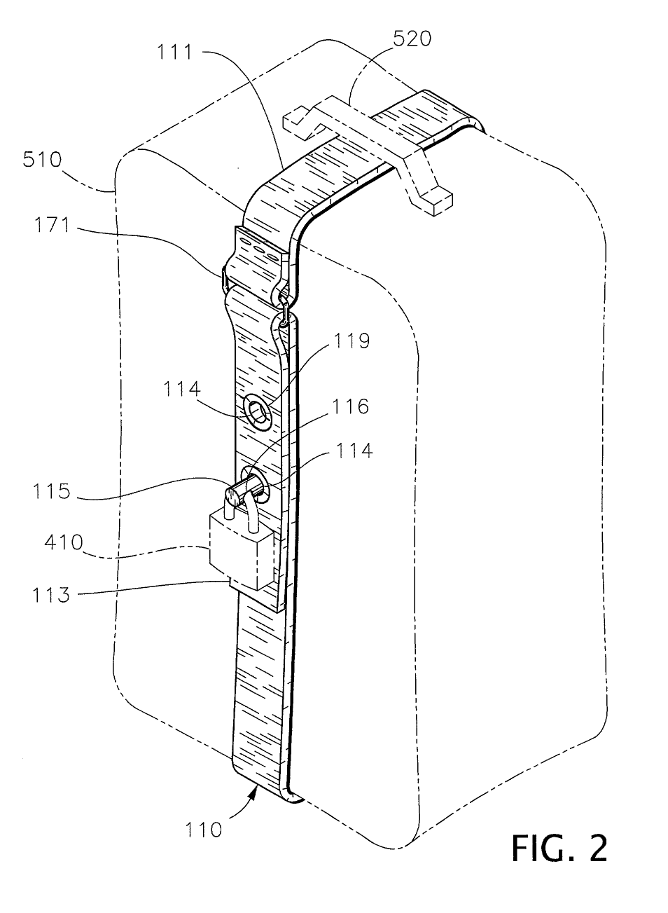

FIG. 2 shows the embodiment of FIG. 1 in place surrounding a piece of luggage 510. The installation procedure starts by placing the piece of luggage in between the ends, then bringing the free end 113 (along with the base 115) under the bottom and up against the front of the piece of luggage. Next, bring the looping end 111 over the top (ideally feeding it though a handle 520 if possible for added security) then hang the looping end over of the top of the piece of luggage. Next, feed the free end up through ring 171 and then downward. While drawing downward, one of the openings 114 of the free end should be placed over the base. While not shown, the present invention could utilize reusable binding means, such as cooperative hook-and-loop elements on overlapping strap surfaces, acting to temporarily hold the free end in place. Finally, a lock 410 which is open is passed through the aperture 116 and is closed to a locking position. Thus, this embodiment of the present invention is shown surrounding and locking the piece of luggage, rendering it highly secure from search or theft.

The looping end 111 has a loop means which (in this embodiment) comprises a ring 171 which is fastened by stitching 170. (Instead of stitching, it could be fastened by heat sealing, bonding, or one or more of a rivet.) An important innovation of the present invention is the “loop means” can be seen to provide the functions of: a) receiving the free end 113 so as to b) return the free end in the opposite direction so that c) when pulled, it acts to tighten the looping end around the piece of luggage 510 with d) a tension that is double the pull force. In this way, the loop means acts similarly to a pulley in a block-and-tackle. This version of loop means is but one of many that we will describe later.

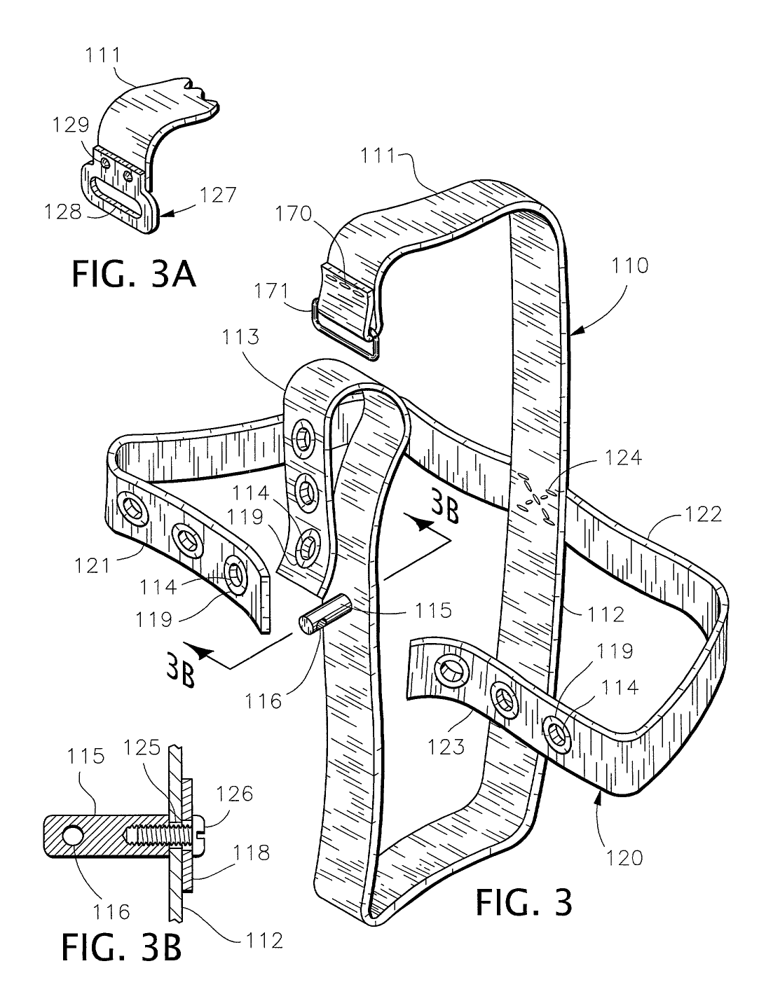

FIG. 3 shows an alternate embodiment of the present invention which comprises all of the elements of the FIG. 1 embodiment and further comprises a second strap 120 which has a first loose end 121, a central portion 122, and a second loose end 123. Each of the loose ends has one or more of a grommet 119 each of which forms an opening 114 having a size which would pass over the base 115. One skilled in the art could place the openings at suitable distances and intervals to accommodate a majority of luggage girths. The middle portion 112 of the first strap 110 is shown attached to the central portion 122 of the second strap 120 by means of a stitching 124. This is but one of many attachment means that we will disclose later.

FIG. 3A shows an alternate loop means comprising a slotted piece 127 having a slot 128 where the slotted piece is attached to the looping end 111 by one or more of a rivet 129. The slotted piece could also be attached by piercing prongs, deformed on the backside. The slotted piece with several small holes could also be attached by stitching.

FIG. 3B shows a means of securing the base 115 to the middle portion 112 of the first strap 110, where one end of the base is shown having a female thread. Fastener 126 passes through a hole 125 in the strap from the rear. This version shows a washer 118 under the fastener head. But, another version, having a fastener head with a large diameter, could omit the washer. Another version could include a second washer (not shown) placed on the other side of the strap. The fastener could be a threaded screw as shown, or could be a drive screw or rivet, secured by an interference fit or cement into a smooth hole in the base. The fastener could be a nut on a threaded stud. Several other means of securing the base will be described later.

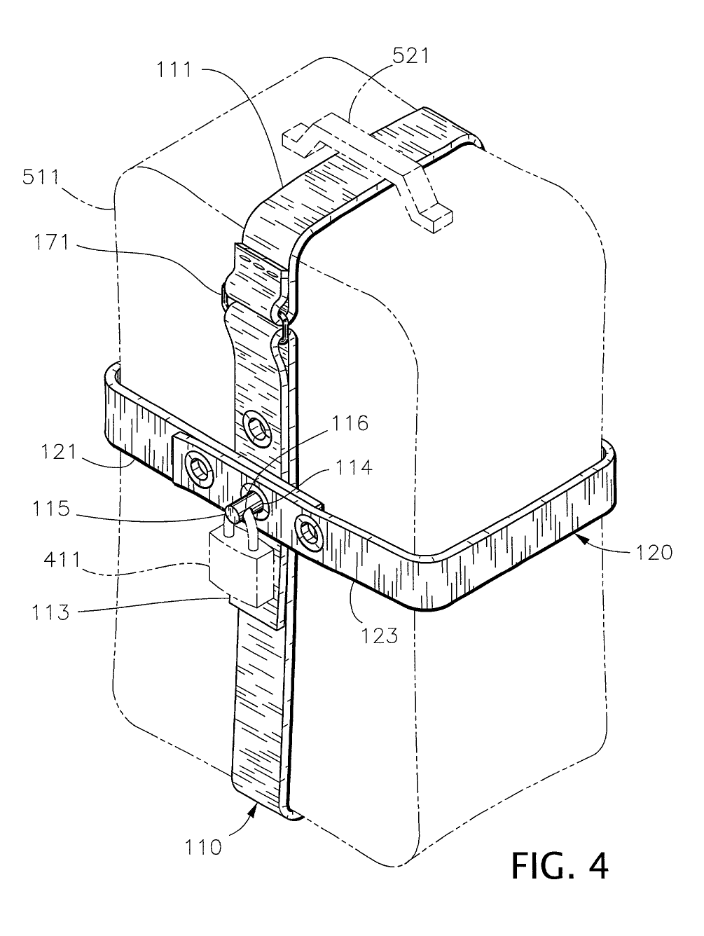

FIG. 4 shows the embodiment of FIG. 3 in place surrounding a piece of luggage 511. The installation procedure starts by placing the piece of luggage in between the ends, then bring the free end 113 (along with the base 115) under the bottom and up against the front of the piece of luggage. Next, bring the looping end 111 over the top (ideally feeding it though the handle 521 if possible for added security) then hang the looping end over of the top of the piece of luggage. Next, feed the free end up through ring 171 and then downward. While drawing downward, one of the openings 114 of the free end should be placed over the base. Next, bring the first loose end 121 around the left side, pull tight and place one of the openings over the base. Similarly, bring the second loose end 123 around the right side, pull tight and place one of the openings over the base. While not shown, the present invention could utilize reusable binding means, such as cooperative hook-and-loop elements on the overlapping strap surfaces, acting to temporarily hold each end in place until all are placed over the base. Finally, a lock 411 which is open is passed through the aperture 116 and is closed to a locking position. While the installation procedure must necessarily begin with placing the base on the front of the piece of luggage, the feeding around of the free end and the bringing around of the two loose ends may proceed in any order desired. Thus, this embodiment of the present invention is shown surrounding and locking the piece of luggage, rendering it highly secure from search or theft.

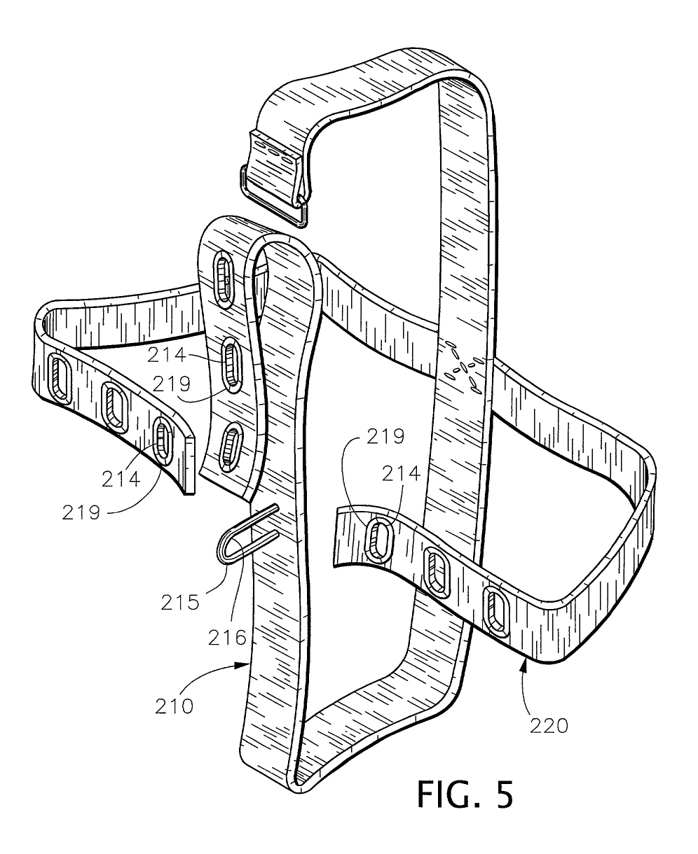

FIG. 5 shows an alternate embodiment of the present invention, which is similar to that shown in FIG.3, having a first strap 210 and a second strap 220, except that the base 215 comprises a staple shape (rather than a cylindrical shape.) There is formed an aperture 216 of a size which would receive a typical lock. In each of the strap ends, there is one or more of an elongated grommet 219 forming one or more of an elongated opening 214. While a large round grommet with a large round opening would work, an elongated opening could have a corresponding size to just pass over the staple shape. It can easily be seen how this embodiment would install and lock around a piece of luggage in a fashion similar to that shown in FIG. 4. The staple shape is shown as a bent rod, but it could also be formed of sheet metal or plastic, punched, sheared, or sawed into the shape of the letter “U.” We envision any of these fabrications of staple shape and their equivalents and other well-known methods and materials to form a base with a staple shape. Every embodiment of the present invention disclosed herein would work equally well having a base with a staple shape.

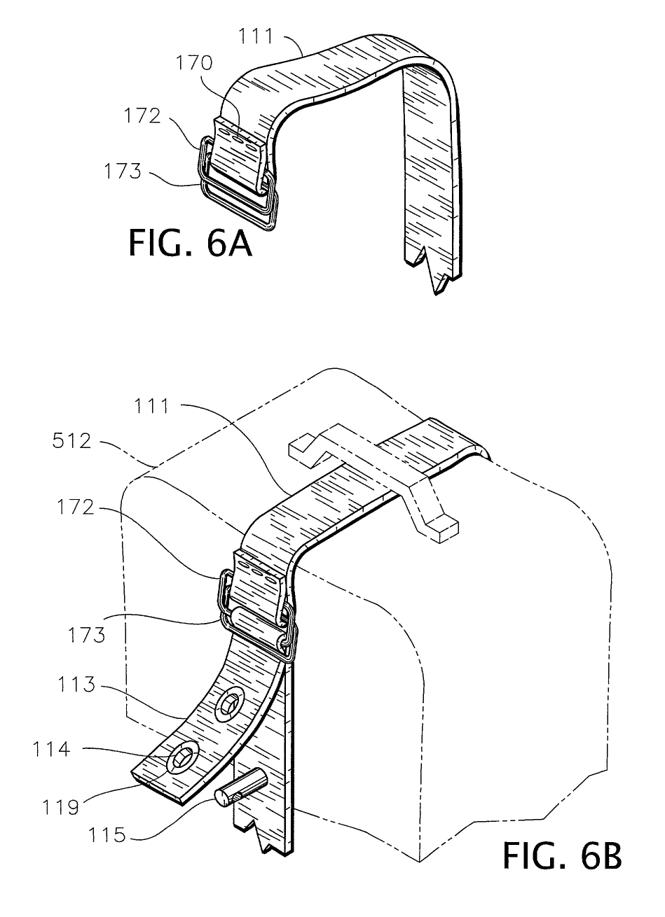

Each of the embodiments of the present invention shown in FIGS. 1 and 3 comprises a loop means. An alternate version of loop means was shown in FIG. 3A. Now in FIG. 6A another version of the loop means is disclosed. There is a first ring 172 and a second ring 173. As shown in FIG. 6B, the free end 113 is drawn outward and over both rings, then rearward through the second ring. The advantage of this version is that, when the free end is pulled down, it tends to stay in position due to the cinching action of the two rings acting in cooperation. Every embodiment of the present invention disclosed herein would work equally well having a loop means comprising two or more rings.

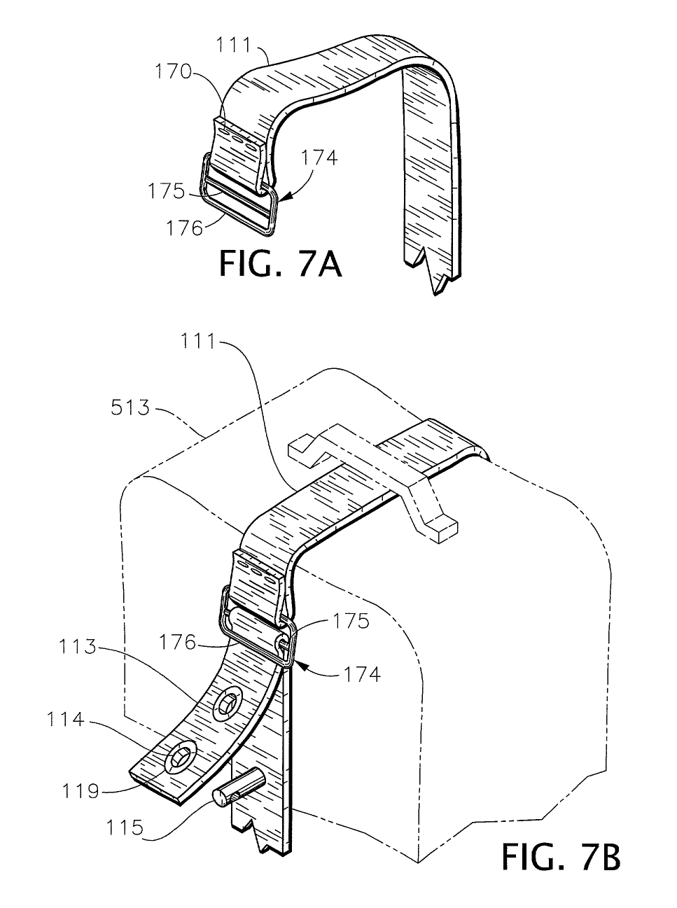

FIG. 7A shows another alternate version of the loop means. There is a draw buckle 174 which has two exposed bars, joined at the sides. As shown in FIG. 7B, the free end 113 is drawn outward and over the middle bar 175, then rearward over the lower bar 176. The advantage to this version is that, when the free end is pulled down, it tends to stay in position due to the cinching action of the two bars acting in cooperation. There are many types of draw buckles commonly available. Some draw buckles are made of stamped sheet metal, some are made of cast metal or molded plastic. For the present invention, a draw buckle is any buckle having at least two bars around which a strap is directed to provide a cinching function as shown in FIG. 7B. Every embodiment of the present invention disclosed herein would work equally well having a loop means comprising a draw buckle.

Each of the embodiments of the present invention shown in FIGS. 1 and 3 comprises a securing means for securing the base 115 to the middle portion 112. Versions of securing means have been shown in FIGS. 1A, 1B, and 3B and described earlier. Another securing means would be bonding. Bonding is defined as including any of a number of materials or methods such as: cements, adhesives, solvents or glues, or by chemical fusing, heat fusing, ultrasonic welding, or friction welding. Every embodiment of the present invention disclosed herein would work equally well having a securing means comprising bonding.

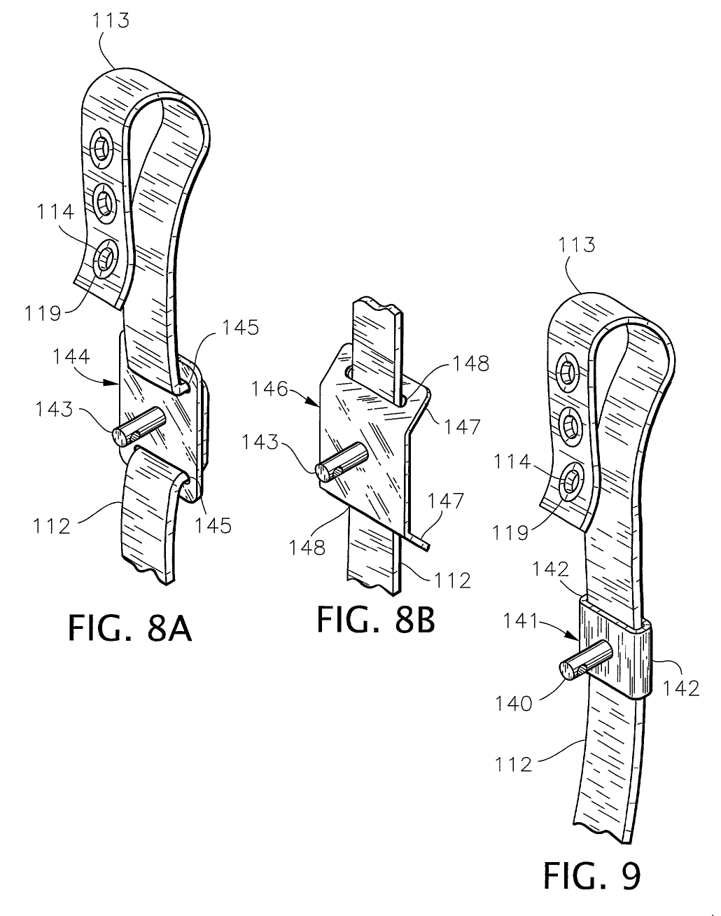

Another securing means is disclosed in FIG. 8A. A base 143 is secured to slotted anchor plate 144 by rivet edge, threaded screw, drive screw, cement, brazing, welding, or the like. Alternately, the base and slotted anchor plate could be made as one integral part by molding or casting. The slotted anchor plate secures the base to the middle portion 112 of the strap by feeding the strap through slots 145. Every embodiment of the present invention disclosed herein would work equally well having a securing means comprising a slotted anchor plate.

Yet another securing means is disclosed in FIG. 8B. The base 143 is secured to a slotted anchor plate 146 having bent ends 147. The base is attached by rivet edge, threaded screw, drive screw, cement, brazing, welding or the like. Alternately, the base and slotted anchor plate could be made as one integral part by molding or casting. The slotted anchor plate secures the base to the middle portion 112 of the strap by feeding the strap through slots 148. This version of securing means is more easily adjusted along the length of the strap than that shown in FIG. 8A. Every embodiment of the present invention disclosed herein would work equally well having a securing means comprising a slotted anchor plate having bent ends.

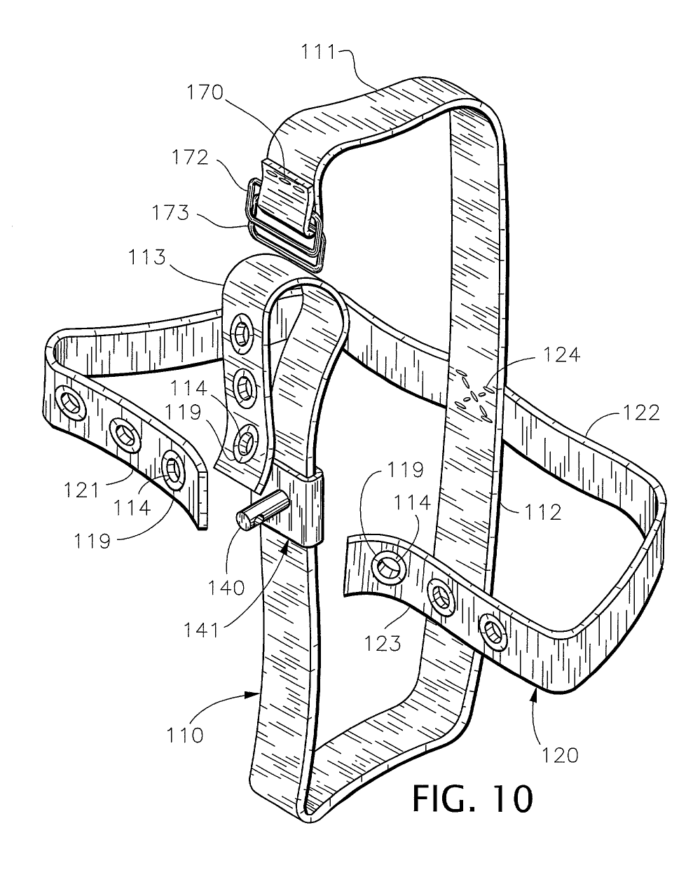

Still another securing means is shown in FIG. 9 where base 140 is secured to mounting clip 141 by rivet edge, threaded screw, drive screw, cement, brazing, welding, or the like. Alternately, the base and mounting clip could be made as one integral part by molding or casting. If made of sheet metal, the mounting clip could be formed by bending each end 142 around to the backside of the strap, creating a “C” shape as viewed from above. Alternately, the mounting clip could be made of a short section of tubing, which could be flattened to provide a wall surrounding the strap without any discontinuity. Every embodiment of the present invention disclosed herein would work equally well having a securing means comprising a mounting clip.

Any of the securing means described in FIGS. 8A. 8B, and 9 could firmly secure the base to the strap by having a close fit. Or, by having a loose fit, the position of the base 140 (or 143) could be adjusted by sliding along the middle portion 112. Therefore, when the free end 113 is drawn tight from the loop means and brought near the base, then the base could be moved to suit a particular opening 114. This arrangement secures the piece of luggage with an infinitely variable surrounding distance. As a minimum, this could be accomplished even if the base were limited to adjust within a range equal to the typical spacing distance between the openings.

Now, the preferred embodiment of the present invention would be one which comprises one of the loop means shown in FIGS. 6A or 7A having a cinching action, and also which comprises one of the securing means shown in FIGS. 8A, 8B, or 9 having a base-adjusting action. One such preferred embodiment is shown in FIG. 10.

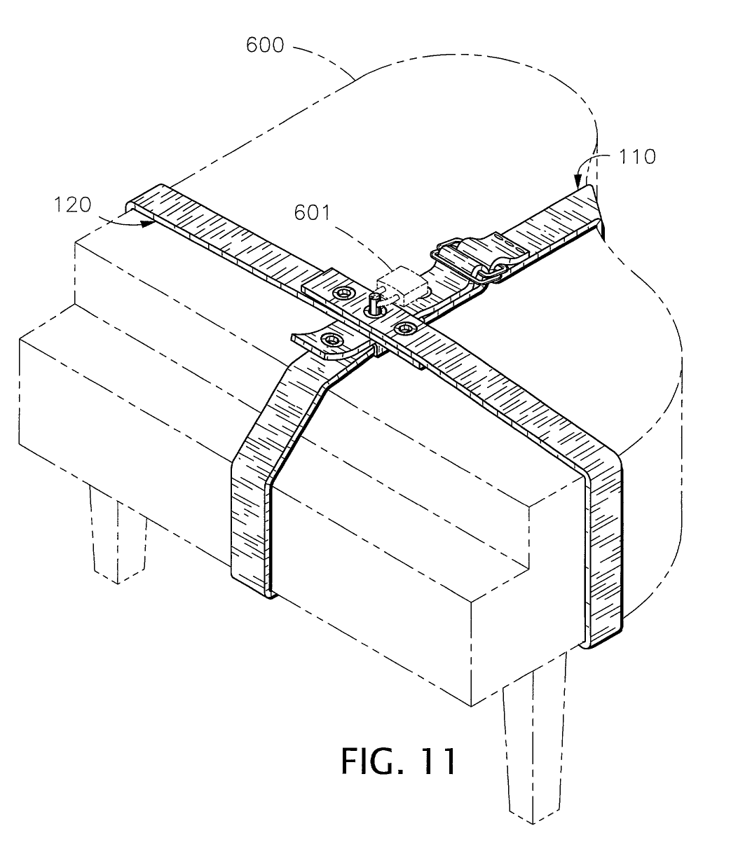

FIG. 11 shows the embodiment of FIG. 10 installed surrounding an object 600 and locking with a lock 601. Likewise, any of the embodiments disclosed herein, would work equally well to surround and lock any object. This demonstrates that, in addition to securing a piece of luggage, the present invention can be used to secure any object.

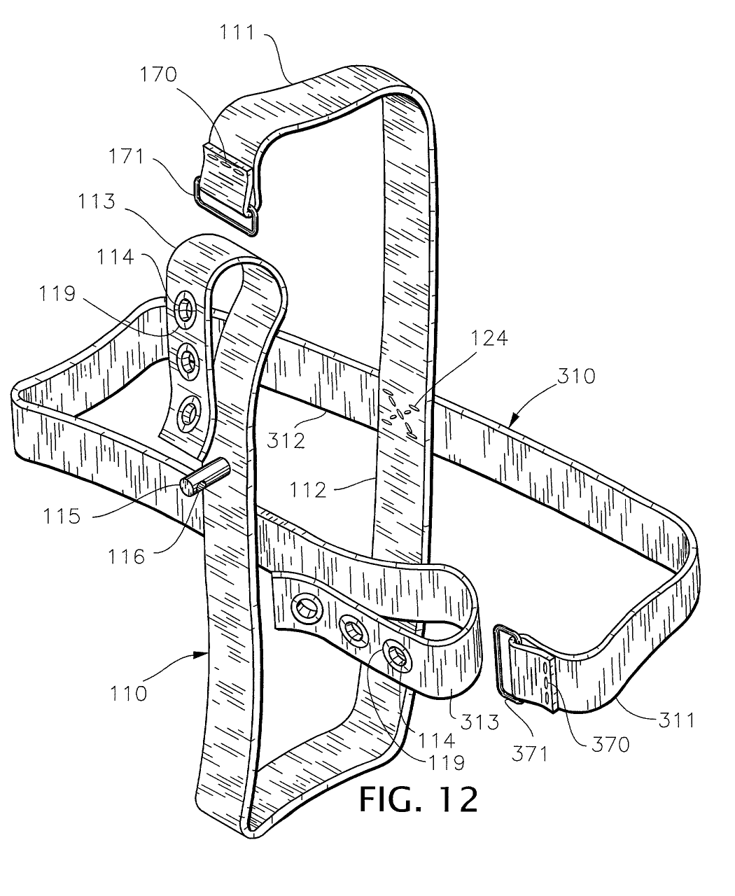

031 Yet another embodiment of the present invention is shown in FIG. 12, which has a first strap 110 identical in construction to that shown in FIGS. 1 or 3. There is a second strap 310 having a looping end 311, a central portion 312, and a loose end 313. The looping end has a ring 371 fastened by stitching 370 (which is but one way of providing a loop means.) The loose end has one or more of a grommet 119 each having an opening 114 having an opening size which would pass over the base 115. When installed on a piece of luggage, the loose end 313 passes behind the free end 113, touching one another, but not being fixed to one another. This embodiment is installed on a piece of luggage using a procedure similar to previously described resulting in FIG. 4, except that there are only two strap ends whose openings are placed over the base before locking with a lock. The advantage of this embodiment of the present invention is that both the first strap and the second strap install around the piece of luggage with the mechanical advantage provided by the loop means described earlier.

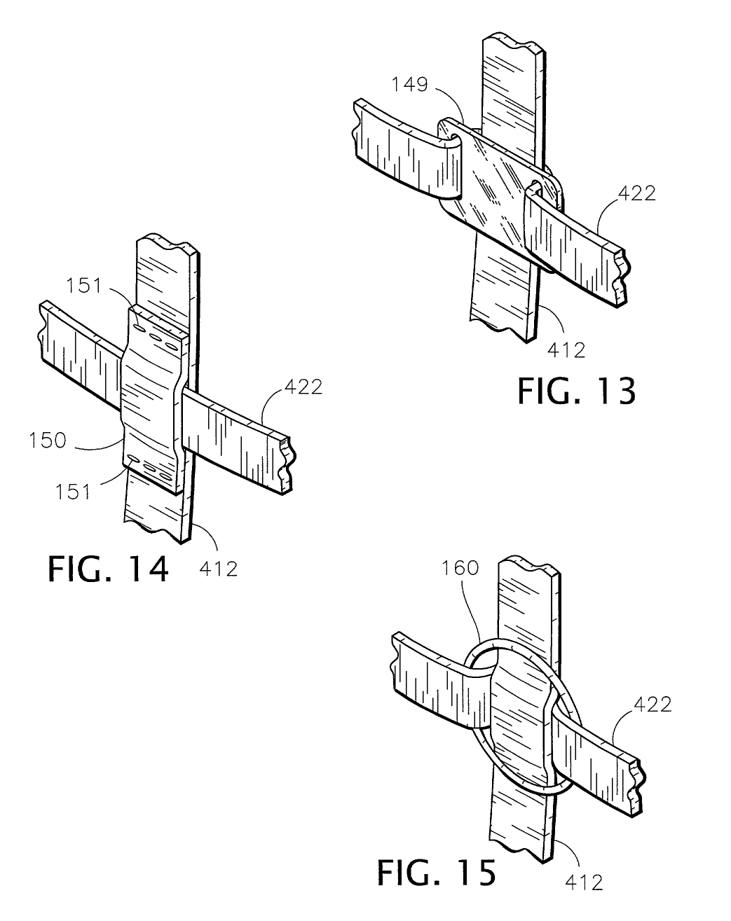

Each of the embodiments of the present invention shown in FIGS. 3, 5, 10 and 12 comprise an attachment means for attaching the middle portion of the first strap to the central portion of the second strap. Alternate attachment means could comprise one or more of a rivet, or by bonding. Bonding is defined as including any of a number of materials or methods such as: cements, adhesives, solvents or glues, or by chemical fusing, heat fusing, ultrasonic welding, or friction welding. Another attachment means is shown in FIG. 13 where a vertical strap 412 (comparable to middle portion 112) is attached to a horizontal strap 422 (comparable to central portion 122) by means of slotted panel 149. Another attachment means is shown in FIG. 14 where the vertical strap is attached to the horizontal strap by means of a splice strip 150 held in place to the vertical strap by stitching 151 so that the horizontal strap is fed between the splice strip and the vertical strap. The splice strip is shown fabricated of a flexible material, but could be made of a rigid material and could be held by rivets, or bonding, instead of stitching. Still another version of attachment means is shown in FIG. 15 where the vertical strap is attached to the horizontal strap by weaving through a ring 160. The ring could also be formed in a square shape or any other non-round shape. Any of these attachment means would work equally well in other orientations such as: reversed, mirrored, or rotated 90°. We envision every embodiment shown herein of the present invention alternately comprising any of these attachment means, and their equivalents.

All embodiments shown comprise one or more straps which could be fabricated of any flexible material. An economical choice would be woven nylon or other woven plastic. Natural woven products such as cotton could be used to make a strap. Nonwoven plastic or leather could be used. For higher security, a woven metal mesh (made of metal wire) or metal chain mail (made of interlocking links or plates) could be used. Almost any material could be utilized to make a strap, provided it was sufficiently thin to flex around the corners of the piece of luggage or object.

While the disclosed embodiments show a flat belt-like shape for the straps, the present invention would function equally well with straps that are very narrow or filament-like.

The present invention is disclosed for use with a lock. Since locks are available in many configurations, we now define a lock as any securing device which comprises a movable shackle, pin, chain, or cable which can be alternately opened or closed; or which, after being inserted through the aperture 116, has a detent action for keeping it in place. Usually, the opening action is restricted to users inserting a key or entering a numerical combination. Our definition of lock includes such devices having restricted opening actions, but it also includes securing devices that exhibit other deterrents to opening. For example, a loop of wire passing though the aperture, whose ends are secured by a deformable security seal would meet our definition of lock. Diaper pins, latching hooks, clevis pins, hitch pins, ball-lock pins, and the like do meet our definition of lock, since their detent action prevents the present invention from inadvertent disassembly.

While the present invention has been shown and described surrounding and locking a typical piece of luggage, this should not be construed as limiting the scope of the invention, but as merely providing illustrative example. There are many shapes and sizes of luggage and other objects around which the present invention could lock and secure, for example the object 600 shown in FIG. 11. Therefore, we envision application of the present invention to surround and lock parcels, packages, shipping crates, containers, and virtually any object. Therefore, the spirit and scope of the appended claims should not be limited to the descriptions of the preferred embodiments contained herein.

We claim:

1. A security device for surrounding an object and for locking with a lock, which device comprises:
a. a first strap having a looping end, a middle portion, and a free end, the looping end having a loop means, the free end having one or more of an opening,
b. a base having an aperture of an aperture size which would receive the lock, the opening having an opening size which would pass over the base,
c. a securing means for securing the base to the middle portion of the first strap.

2. A security device for surrounding an object and for locking with a lock, which device comprises:
a. a first strap having a looping end, a middle portion, and a free end, the looping end having a loop means, the free end having one or more of an opening,
b. a base having an aperture of an aperture size which would receive the lock, the opening having an opening size which would pass over the base,
c. a securing means for securing the base to the middle portion of the first strap,
d. a second strap, having a first loose end, a central portion, and a second loose end, the first loose end having one or more of the opening, the second loose end having one or more of the opening,
e. an attachment means for attaching the middle portion of the first strap to the central portion of the second strap.

3. A luggage security device for surrounding a piece of luggage and for locking with a lock, which device comprises:
a. a first strap having a looping end, a middle portion, and a free end, the looping end having a loop means, the free end having one or more of an opening,
b. a base having an aperture of an aperture size which would receive the lock, the opening having an opening size which would pass over the base,
c. a securing means for securing the base to the middle portion of the first strap.

4. The luggage security device of claim 3, wherein the base comprises a cylindrical shape.

5. The luggage security device of claim 3, wherein the base comprises a staple shape.

6. The luggage security device of claim 3, wherein the securing means comprises a face plate.

7. The luggage security device of claim 3, wherein the securing means comprises a rolled rivet edge.

8. The luggage security device of claim 3, wherein the securing means comprises a fastener.

9. The luggage security device of claim 3, wherein the securing means comprises bonding.

10. The luggage security device of claim 3, wherein the securing means comprises a slotted anchor plate.

11. The luggage security device of claim 3, wherein the securing means comprises a mounting clip.

12. The luggage security device of claim 3, wherein the loop means comprises one or more of a ring.

13. The luggage security device of claim 3, wherein the loop means comprises a slotted piece.

14. The luggage security device of claim 3, wherein the loop means comprises a draw buckle.

15. A luggage security device for surrounding a piece of luggage and for locking with a lock, which device comprises:
a. a first strap having a looping end, a middle portion, and a free end, the looping end having a loop means, the free end having one or more of an opening,
b. a base having an aperture of an aperture size which would receive the lock, the opening having an opening size which would pass over the base,
c. a securing means for securing the base to the middle portion of the first strap,
d. a second strap, having a first loose end, a central portion, and a second loose end, the first loose end having one or more of the opening, the second loose end having one or more of the opening,
e. an attachment means for attaching the middle portion of the first strap to the central portion of the second strap.

16. The luggage security device of claim 15, wherein the base comprises a cylindrical shape.

17. The luggage security device of claim 15, wherein the base comprises a staple shape.

18. The luggage security device of claim 15, wherein the attachment means comprises a stitching.

19. The luggage security device of claim 15, wherein the attachment means comprises one or more of a rivet.

20. The luggage security device of claim 15, wherein the attachment means comprises bonding.

21. The luggage security device of claim 15, wherein the attachment means comprises a slotted panel.

22. The luggage security device of claim 15, wherein the attachment means comprises a splice strip.

23. The luggage security device of claim 15, wherein the attachment means comprises a ring.

24. A luggage security device for surrounding a piece of luggage and for locking with a lock, which device comprises:
a. a first strap having a looping end, a middle portion, and a free end, the looping end having a looping means comprising one or more of a ring, the free end having one or more of an opening,
b. a base having an aperture of an aperture size which would receive the lock, the opening having an opening size which would pass over the base,
c. a mounting clip for securing the base to the middle portion of the first strap,
d. a second strap, having a first loose end, a central portion, and a second loose end, the first loose end having one or more of the opening, the second loose end having one or more of the opening,
e. an attachment means for attaching the middle portion of the first strap to the central portion of the second strap.

25. A luggage security device for surrounding a piece of luggage and for locking with a lock, which device comprises:
a. a first strap having a first looping end, a middle portion, and a free end, the first looping end having a first loop means, the free end having one or more of an opening,
b. a base having an aperture of an aperture size which would receive the lock, the opening having an opening size which would pass over the base,
c. a securing means for securing the base to the middle portion of the first strap,
d. a second strap, having a second looping end, a central portion, and a loose end, the second looping end having a second loop means, the loose end having one or more of the opening,
e. an attachment means for attaching the middle portion of the first strap to the central portion of the second strap.
